(19) United States
(12) Patent Application Publication
(10) Pub. No.: US 2016/0227235 A1
(43) Pub. Date: Aug. 4, 2016

(54) WIRELESS BANDWIDTH REDUCTION IN AN ENCODER

(71) Applicants: Yaniv Frishman, Kiryat Ono (IL); Etan Shirron, Hod-Hasharon (IL)

(72) Inventors: Yaniv Frishman, Kiryat Ono (IL); Etan Shirron, Hod-Hasharon (IL)

(21) Appl. No.: 14/671,794

(22) Filed: Mar. 27, 2015

Related U.S. Application Data
(60) Provisional application No. 62/111,076, filed on Feb. 2, 2015.

(51) Int. Cl. H04N 19/423; H04N 19/593; H04N 19/85; H04N 19/44

(52) U.S. Cl. CPC H04N 19/423; H04N 19/44; H04N 19/593; H04N 19/85

(57) ABSTRACT

Systems, apparatus, articles, and methods are described below including operations for wireless bandwidth (BW) reduction in an encoder.

### RELATED APPLICATIONS

The present application claims the benefit of U.S. Provisional Application No. 62/111,076, filed 2 Feb. 2015, and titled “WIRELESS BANDWIDTH REDUCTION WITH AN INTA ONLY ENCODER”, the contents of which are expressly incorporated herein in their entirety.

### BACKGROUND

A video encoder compresses video information so that more information can be sent over a given bandwidth. The compressed signal may then be transmitted to a receiver that decodes or decompresses the signal prior to display.

Some previous encoders either do not reduce wireless bandwidth or employ a complex video encoder (which can generate P macroblocks and uses a reference frame containing the previously decoded pixels).

Other conventional encoders either require monitoring screen updates via SW (e.g., requiring the OS to notify when the screen will not be updated) or require knowledge that the frame is static before it is encoded in order to save power. Other solutions compare the incoming pixels with the previously decoded image (the reference frame) thus requiring high memory bandwidth and additional power.

Still other conventional encoders typically either encode all video frames, wasting power and bandwidth, or relay on information from the OS/playback application in order to know what is the refresh rate of the content being displayed. Further, previous solutions are typically targeted mainly at full screen video playback. Most previous solutions don't take information about static video frames into account. Thus power and wireless bandwidth may be wasted encoding static video frames.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 is an illustrative diagram of an example video processing system;

FIG. 2A is an illustrative diagram of an example video processing scheme;

FIG. 2B is an illustrative diagram of an example video processing scheme;

FIG. 3 is an illustrative diagram of an example video processing scheme;

FIG. 4 is an illustrative diagram of an example video processing scheme;

FIG. 5 is a flow diagram illustrating an example frame rate estimator;

FIG. 6 is a flow diagram illustrating an example coding process;

FIG. 7 provides an illustrative diagram of an example video coding system and video coding process in operation;

FIG. 8 is an illustrative diagram of an example video coding system;

FIG. 9 is an illustrative diagram of an example system; and

FIG. 10 is an illustrative diagram of an example system, all arranged in accordance with at least some implementations of the present disclosure.

### DETAILED DESCRIPTION

While the following description sets forth various implementations that may be manifested in architectures such system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to effect such feature, structure, or characteristic in connection with other implementations whether or not explicitly described herein.

Systems, apparatus, articles, and methods are described below including operations for wireless bandwidth (BW) reduction in an encoder.

As described above, some previous encoders either do not reduce wireless bandwidth or employ a complex video encoder (which can generate P macroblocks and uses a reference frame containing the previously decoded pixels).

Other conventional encoders either require monitoring screen updates via SW (e.g., requiring the OS to notify when the screen will not be updated) or require knowledge that the frame is static before it is encoded in order to save power. Other solutions compare the incoming pixels with the previously decoded image (the reference frame) thus requiring high memory bandwidth and additional power.

Still other conventional encoders typically either encode all video frames, wasting power and bandwidth, or relay on information from the OS/playback application in order to know what is the refresh rate of the content being displayed. Further, previous solutions are typically targeted mainly at full screen video playback. Most previous solutions don't take information about static video frames into account. Thus power and wireless bandwidth may be wasted encoding static video frames.

As will be described in more detail below, in some implementations described herein an encoder may be designed to reduce wireless bandwidth when an Intra only encoder is used for wireless display. An example is WiGig WDE. Previous solutions either do not reduce wireless bandwidth or employ a much more complex video encoder (which can generate P macroblocks and uses a reference frame containing the previously decoded pixels).

In other implementations described herein, an encoder may be designed to reduce encoder power consumption of a video encoder used for wireless display. Such implementations may be able to save power and wireless bandwidth when the encoded content is static. This is often the case in workloads such as productivity work, e.g. editing documents, emailing.

In still other implementations described herein, an encoder may be designed to reduce video encoder power consumption and wireless transmission bandwidth in a wireless display application where the contents of the screen are sometimes static. An example is video playback: while the computer screen is normally set to refresh at 60 frames per second (FPS), the video content uses a lower rate, e.g. 30 FPS.

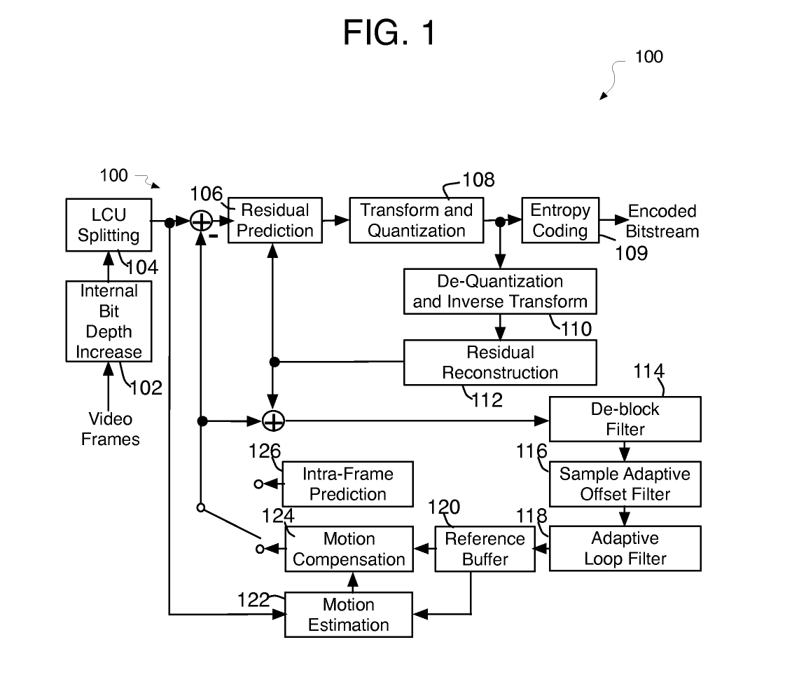

FIG. 1 is an illustrative diagram of an example video coding system 100, arranged in accordance with at least some implementations of the present disclosure. In various implementations, video coding system 100 may be configured to undertake video coding and/or implement video codecs according to one or more advanced video codec standards.

As will be described in more detail below, in some implementations described herein an encoder of video coding system 100 may be designed to reduce wireless bandwidth when an Intra only encoder is used for wireless display. An example is WiGig WDE. Previous solutions either do not reduce wireless bandwidth or employ a much more complex video encoder (which can generate P macroblocks and uses a reference frame containing the previously decoded pixels). However, this is only one example, and more complex encoders with additional components illustrated in FIG. 1, may be utilized in conjunction with the techniques described herein.

Further, in various embodiments, video coding system 100 may be implemented as part of an image processor, video processor, and/or media processor and may undertake inter prediction, intra prediction, predictive coding, and/or the like in accordance with the present disclosure.

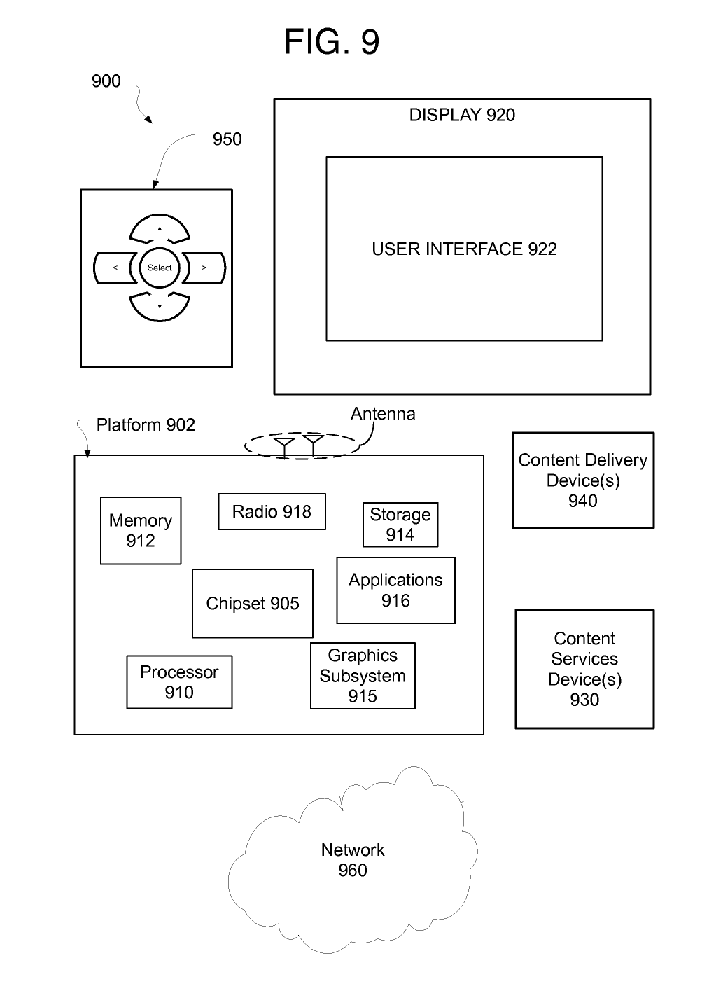

As used herein, the term “coder” may refer to an encoder and/or a decoder. Similarly, as used herein, the term “coding” may refer to encoding via an encoder and/or decoding via a decoder. For example video encoders and video decoders as described herein (e.g., see FIG. 9) may both be examples of coders capable of coding.

In some examples, video coding system 100 may include additional items that have not been shown in FIG. 1 for the sake of clarity. For example, video coding system 100 may include a processor, a radio frequency-type (RF) transceiver, a display, and/or an antenna. Further, video coding system 100 may include additional items such as a speaker, a microphone, an accelerometer, memory, a router, network interface logic, etc. that have not been shown in FIG. 1 for the sake of clarity.

In some examples, during the operation of video coding system 100, current video information may be provided to an internal bit depth increase module 102 in the form of a frame of video data. The current video frame may be split into Largest Coding Units (LCUs) at module 104 and then passed to a residual prediction module 106. The output of residual prediction module 106 may be subjected to known video transform and quantization processes by a transform and quantization module 108. The output of transform and quantization module 108 may be provided to an entropy coding module 109 and to a de-quantization and inverse transform module 110. Entropy coding module 109 may output an entropy encoded bitstream 111 for communication to a corresponding decoder.

Within the internal decoding loop of video coding system 100, de-quantization and inverse transform module 110 may implement the inverse of the operations undertaken by transform and quantization module 108 to provide the output of residual prediction module 106 to a residual reconstruction module 112. Those skilled in the art may recognize that transform and quantization modules and de-quantization and inverse transform modules as described herein may employ scaling techniques. The output of residual reconstruction module 112 may be fed back to residual prediction module 106 and may also be provided to a loop including a de-blocking filter 114, a sample adaptive offset filter 116, an adaptive loop filter 118, a buffer 120, a motion estimation module 122, a motion compensation module 124 and an intra-frame prediction module 126. As shown in FIG. 1, the output of either motion compensation module 124 or intra-frame prediction module 126 is both combined with the output of residual prediction module 106 as input to de-blocking filter 114, and is differenced with the output of LCU splitting module 104 to act as input to residual prediction module 106.

As will be described in more detail below, in some implementations described herein an encoder may be designed to reduce wireless bandwidth when an Intra only encoder is used for wireless display. An example is WiGig WDE. Previous solutions either do not reduce wireless bandwidth or employ a much more complex video encoder (which can generate P macroblocks and uses a reference frame containing the previously decoded pixels).

In other implementations described herein, an encoder may be designed to reduce encoder power consumption of a video encoder used for wireless display. Such implementations may be able to save power and wireless bandwidth when the encoded content is static. This is often the case in workloads such as productivity work, e.g. editing documents, emailing.

In still other implementations described herein, an encoder may be designed to reduce video encoder power consumption and wireless transmission bandwidth in a wireless display application where the contents of the screen are sometimes static. An example is video playback: while the computer screen is normally set to refresh at 60 frames per second (FPS), the video content uses a lower rate, e.g. 30 FPS.

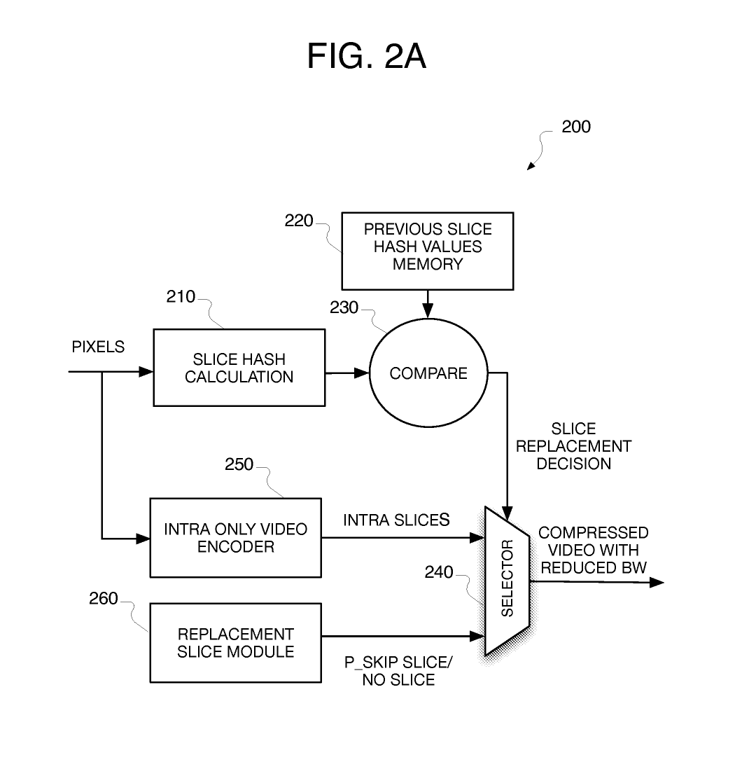

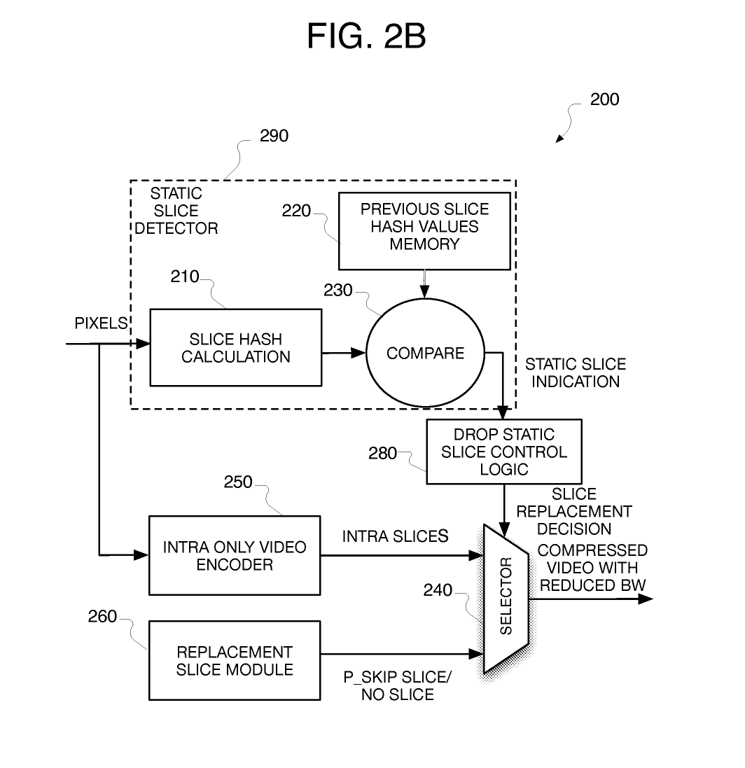

As will be discussed in greater detail below, video coding system 100 may be used to perform some or all of the various functions discussed below in connection with FIGS. 2-5.

FIG. 2A is an illustrative diagram of an example video processing scheme 200, arranged in accordance with at least some implementations of the present disclosure. In various implementations, video processing scheme 200 may reduce wireless bandwidth when an Intra only encoder is used for wireless display. An example is WiGig WDE.

As illustrated, a hash value may be calculated via a slice hash calculation module 210 of video processing scheme 200 for each slice of the image to be encoded. For example, CRC64 can be used. The hash value for a given slice may be stored in the previous slice hash value memory 220. For each video frame, the new hash value of individual slices may be compared to the corresponding old slice hash value via comparison module 230. If they match, the slice is identical. If not, the slices are different. The result of the hash comparison (e.g., a slice replacement decision by comparison module 230 based at least in part on the hash comparison) may be fed to a selector 240.

In parallel, the pixels get encoded using an Intra only encoder 250. For example, video processing scheme 200 may make slight modifications to an Intra only encoder, which may provide for WDE, a wireless BW savings on par with a much more complex, costly and power consuming video encoder which supports P_skip at the macroblock (MB) level. Additional components in the encoder may include a static slice detector and support for dropping static slices or replacing them with P_skip slices (e.g., containing all P_skip MBs).

If the hash of the slice is identical to the hash of the co-located slice from the previous video frame, instead of transmitting the Intra slice generated by the encoder, the slice is either dropped altogether or replaced by a P_skip slice from a replacement slice module 260, via selector 240.

In such an example, on the decoder side, the missing/P_skip slices get replaced by the decoded pixels from the previous video frame.

Previous solutions either do not reduce wireless bandwidth or employ a much more complex video encoder (which can generate P macroblocks and uses a reference frame containing the previously decoded pixels).

Instead, video processing scheme 200 may detect, at the slice level, if the pixels in the slice are identical to the previous video frame. If the pixels are identical, all packets belonging to the slice are either discarded (instead of being transmitted) or a p_skip slice (which is very small) is transmitted instead. Thus, wireless bandwidth is considerably reduced for static content.

Video processing scheme 200 may achieve roughly the same wireless bandwidth saving as a much more complex video encoder which supports P_skip at the macroblock level. This is achieved by adding a pixel comparison unit to a very simple Intra only encoder. As an example, a Mobile Mark 2012 Blu-ray video playback test contains 61% static macro block rows and 67% static macroblocks (MBs). Thus, detecting static MB rows and discarding the corresponding packets, will result in saving wireless bandwidth almost as much as using a more complex and costly encoder, which can work at the MB level, but requires more power to perform the video encoding.

The WDE spec partitions each video frame into many slices. There are between 1 and 16 slices in each MB row. Further, the WDE spec limits each MB to either be an Intra MB or a P_skip MB (there are no P MBs with non-zero residual or non-zero motion vector). Thus, WDE encoder designers can either use an Intra only encoder or one that also supports P_skip MBs. While it is much easier, cheaper and faster to develop an Intra only encoder, it is not efficient in cases where content is static. An example is office productivity work, where large parts of the screen remain static, while others get updated (e.g. mouse movement). On the other hand, developing an encoder that supports P_skip at the MB level is more complex. Such an encoder uses a reference frame, containing the previously decoded image. Such an encoder compares the new image to the reference frame, and makes a mode decision per MB: encoding as an Intra MB or as a P_skip MB. Such a design is complex, consumes more power, and needs expensive storage for a reference frame. As the WDE spec uses very high image quality (for wireless docking applications), it may be reasonable to assume that if a slice or MB was modified, the encoder will elect to re-encode the modified region using Intra encoding. Further, in many cases, the difference in wireless bandwidth between re-encoding at the MB level and at the slice level (which is still sub MB-row level) is small.

Accordingly, video processing scheme 200 may be used in a WiGig wireless SoC in order to significantly improve their video encoder performance, while employing a simple, cheap, low power Intra only video encoder.

FIG. 2B is an illustrative diagram of an example video processing scheme 200, arranged in accordance with at least some implementations of the present disclosure. In various implementations, video processing scheme 200 may include a drop static slice control logic 280 in conjunction with a static slice detection circuit 290.

Some implementations described herein may add HW to the video encoder, which detects if the video slice was static or not. For example, drop static slice control logic 280 may be used to look for X consecutive video frames where a given slice is static.

In the illustrated example, static slice detection circuit 290 may receive as input the pixels to be encoded. Static slice detector 290 may calculate a hash value of the pixels in a given slice via slice hash calculation module 210, for example using CRC64. The hash value of a given slice may be stored in the previous slice hash value memory 220. For each video slice, the new hash value may be compared to the old hash value via comparison module 230. If they match, the slice is identical. If not, the slices are different. The result of the hash comparison (e.g., slice static/not static indication) may be fed to drop static slice control logic 280.

In order to improve the image quality, drop static slice control logic 280 may decide that a slice can be dropped after X consecutive video frames where it is static. This can give a chance for the encoder to improve the image quality, e.g. after a scene change. Also note that in order to improve wireless channel robustness, it is possible to occasionally generate and transmit an Intra refresh for a slice, even when it is static.

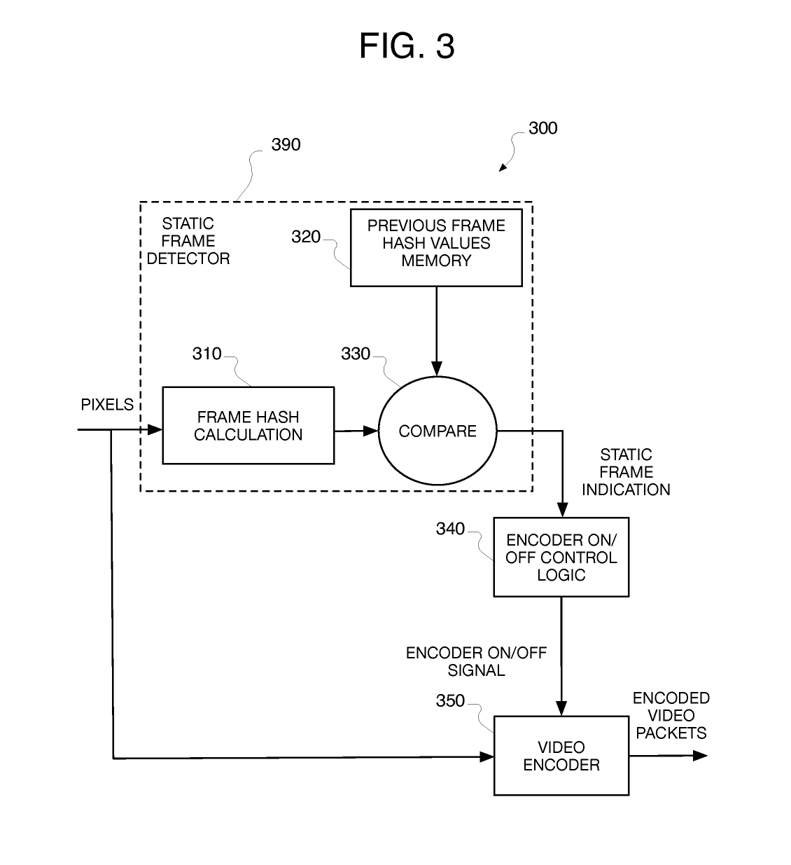

FIG. 3 is an illustrative diagram of an example video processing scheme video processing scheme 300, arranged in accordance with at least some implementations of the present disclosure. In various implementations, video processing scheme 300 may reduce encoder power consumption of a video encoder 350 used for wireless display. Such implementations may be able to save power and wireless bandwidth when the encoded content is static. This is often the case in workloads such as productivity work, e.g. editing documents, emailing.

Video processing scheme 300 may add two components to a standard wireless display video encoder. First, a static image detection circuit 390 and control logic 340 (encoder on/of control logic 340) may determine if the encoder will be on or off during the next video frame, as illustrated in FIG. 3.

For example, static image detection unit 390 may receive the pixels and calculate, for each video frame, a hash of the incoming pixels via hash calculation module 310. An example of a hash function is CRC64. The calculated hash value may be stored in a previous frame hash value memory 320. When a new hash is calculated, it is compared to the previous hash (stored in memory) via comparison module 330. If the hash values are identical, a static frame indication is provided to encoder on/off control logic 340 from comparison module 230.

In this example, encoder on/off control logic 340 may determined if encoder 350 will be on or off during the next video frame. As noted above, static frame detection unit 390 of video processing scheme 300 may compare the new video frame to the previous one by hashing pixel values. Encoder 350 may be shutdown when a sequence of X identical video frames is detected via encoder on/off control logic 340. Encoder 350 may be turned on again, via encoder on/off control logic 340, only after the image changes or for periodic Intra refreshes. Turning encoder 350 completely off may save considerable power and wireless bandwidth.

In operation, if static image detection unit 290 detects that the image is not static, the encoder will be turned on during the next video frame. If the image is static for X consecutive video frames, encoder 350 will be turned off until a change in the image is detected. The value of X may be application dependent. A higher value helps ensure a full video frame is transmitted over the wireless link before the encoder is turned off. This is since the same image is sent several times, helping increase the probability of successful reception. In addition, some encoders gradually improve the quality of static images over time. So sending the same image several times will also improve the quality before the encoder is turned off. In order to ensure clock synchronization between the encoder and decoder are kept, and in order to improve system robustness and ensure there are no long lasting visible artifacts due to missing packets, the encoder on/off control logic 340 may trigger an Intra refresh, e.g., turns on the encoder periodically while the image is still static. Finally, when a change in the image is detected, encoder 350 is turned on again. Encoder 350 may keep encoding until the next sequence of X static images is detected.

Note that on the receiver side, error concealment may be implemented for video frames that are not encoded. In this case, the receiver may simply re-display the static image that was not transmitted.

Previous solutions either require monitoring screen updates via SW (e.g., requiring the OS to notify when the screen will not be updated) or require knowledge that the frame is static before it is encoded in order to save power. Other solutions compare the incoming pixels with the previously decoded image (the reference frame) thus requiring high memory bandwidth and additional power.

In contrast, the implementation of FIG. 3 does not depend on static notifications from SW, and can still save power even when static detection is done after all pixels are presented to the encoder.

Additionally, some implementations described herein may be an improvement over depending on static frame notification from SW since this may not be available in all operating systems, is more complex to integrate, and may not be reliable (e.g. inability to detect a static video frame during full screen playback of a compressed movie).

Further, video processing scheme 300 may be an improvement over depending on static frame notification at the start of the video frame (e.g. static frame notification by the display engine) since this typically requires a dedicated interface from the display engine, which is not available in all systems. In addition, some implementations described herein may be self-contained and may not depend on the ability to detect static frames in the display engine.

Video processing scheme 300 may be utilized as part of a WiGig wireless SoC, targeting wireless docking for business applications. In these use cases, it has been observed that there are often sequences of static video frames (e.g. while reading a document). By detecting such sequences and shutting off the video encoder, the average power consumption and wireless bandwidth consumed by the WiGig wireless SoC may be significantly reduced. All of this may be achieved without any SW intervention and without dedicated signaling from the GPU, thus implementations described herein may be simpler than conventional solutions. At the same time, the encoder may be able to maintain a robust image over a wireless link by performing periodic intra refresh, e.g., encoding and transmitting the static frame once in a while.

Accordingly, video processing scheme 300 may be used in a WiGig wireless SoC in order to significantly reduce power consumption and wireless bandwidth for cases such as performing productivity work on a PC (e.g. editing documents). This has been achieved while using a simple and power efficient encoder, supporting Intra only encoding, which is allowed in the WDE standard.

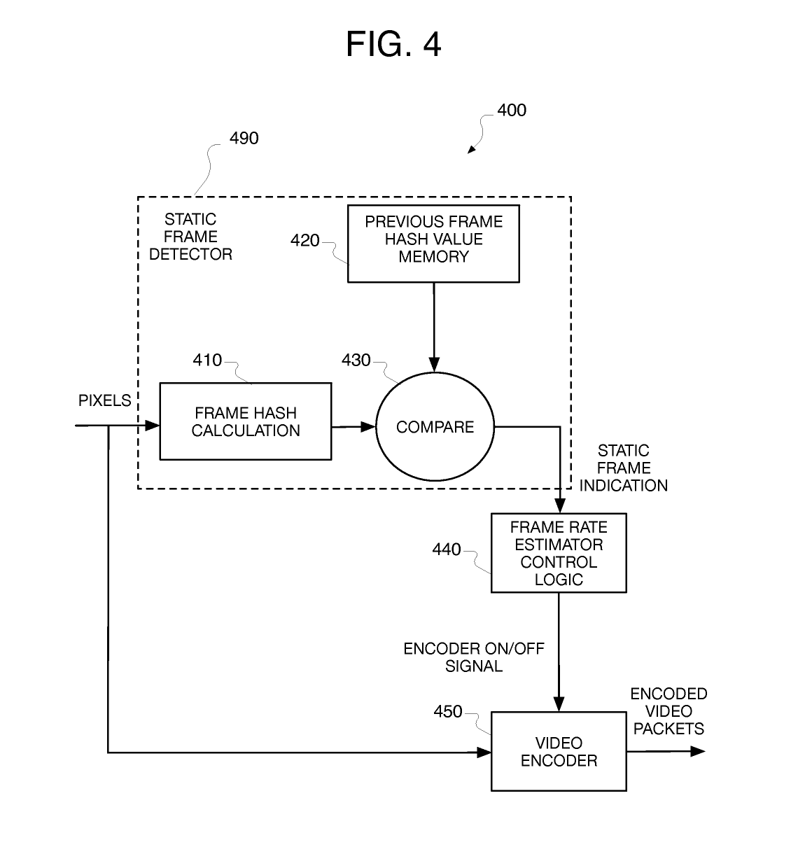

FIG. 4 is an illustrative diagram of an example video processing scheme 400, arranged in accordance with at least some implementations of the present disclosure. In various implementations, video processing scheme 400 may reduce video encoder power consumption and wireless transmission bandwidth in a wireless display application where the contents of the screen is sometimes static. An example is video playback: while the computer screen is normally set to refresh at 60 frames per second (FPS), the video content uses a lower rate, e.g. 30 FPS.

Video processing scheme 400 may include the following modules: a static frame detector 490, a frame rate estimator control logic 440, and a video encoder 450. Video processing scheme 400 may use the frame rate estimator control logic 440 to detect the actual frame update pattern (e.g. 2 frames updated, then 3 static frames), predict future patterns, and turn video encoder 450 on/off based at least in part on the predicted the future patterns.

For example, static frame detection unit 490 may receive the pixels and calculate, for each video frame, a hash of the incoming pixels via hash calculation module 410. An example of a hash function is CRC64. The calculated frame hash value may be stored in a previous frame hash value memory 420. When a new frame hash is calculated, it is compared to the previous frame hash (stored in memory) via comparison module 430. If the hash values are identical, a static frame indication is provided to frame rate estimator control logic 440 from comparison module 430.

In this example, encoder 450 may be turned on/off according to the predicted pattern determined by frame rate estimator control logic 440. If the pattern changes, this is detected by frame rate estimator control logic 440, and encoder 450 may stay on (e.g. when moving a mouse on top of full screen video playback).

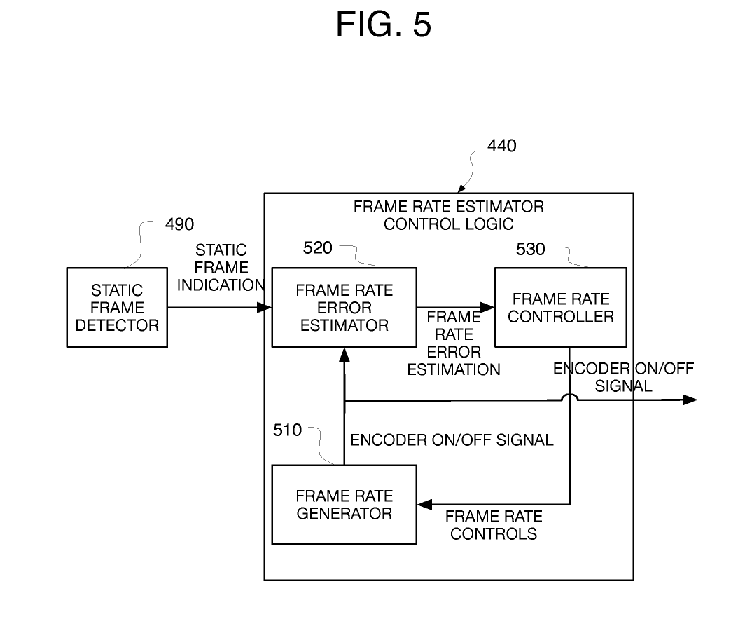

Further, frame rate estimator control logic 440 may be configured to learn new patterns on the fly. More details regarding frame rate estimator control logic 440 may be found below with regard to FIG. 5.

All or part of video processing scheme 400 may be self-contained in the video encoder 450 itself, and may not need help and/or hints from external SW and/or from the operating system, which may not cover all cases where the frame rate can be reduced.

Previous solutions typically either encode all video frames, wasting power and bandwidth, or relay on information from the OS/playback application in order to know what is the refresh rate of the content being displayed. Further, previous solutions are typically targeted mainly at full screen video playback. Most previous solutions don't take information about static video frames into account. Thus power and wireless bandwidth may be wasted encoding static video frames.

Conversely, some implementations described herein may add HW to the video encoder, which detects if the video frame was static or not. Then, a frame rate estimator may be used to look for a pattern of changed video frames (e.g. content changes once in 2 video frames). Finally, the video encoder may be programmed to be turned off according to the detected pattern.

Most previous solutions don't take information about static video frames into account. Thus power and wireless bandwidth may be wasted encoding static video frames. Other previous solutions typically require hints to the encoder about the content type and the refresh rate of the content. An example is when a movie that updates at 24 FPS is played full screen on a computer that refreshes the display at 60 FPS.

Conversely, some implementations described herein may have the graphics driver notify the video encoder that the screen will be updated at 24 FPS, and the video encoder will be turned on/off accordingly. A more difficult example is a website which contains some animation, e.g. a flash based commercial. It is difficult to predict the frame rate at which such content will be updated, so the encoder may be turned on for each frame.

FIG. 5 is a diagram illustrating an example frame rate estimator 440, arranged in accordance with at least some implementations of the present disclosure. In various implementations, frame rate estimator 440 can be implemented in hardware, software or a combination of both.

For example, frame rate estimator 440 can be based on the following building blocks: static frame detector 490 (which may be separate from or incorporated with frame rate estimator 440), frame rate generator module 510, frame rate error estimator module 520, frame rate controller module 530, the like, and/or combinations thereof.

In the illustrated example, static frame detector 490 may provide a static frame indicator. For example, for every frame, an indication may be provided as input, stating if the frame is similar to or different from the previous frame.

In the illustrated example, frame rate generator module 510 may be capable of generating a programmable frame rate, between 0 and the maximum frame rate, at a pre-defined granularity.

In the illustrated example, frame rate error estimator module 520 may be capable of estimating the error in phase and frequency between the incoming frame rate (from the static frame detector 490) and the frame rate generated by frame rate generator module 510.

In the illustrated example, frame rate controller module 530 may be capable of controlling frame rate generator module 510 based at least in part on the frame rate error estimation output from frame rate error estimator module 520. Frame rate controller module 530 also may perform the decision if a stable reduced frame rate was detected, and determine in which mode the system shall operate: Maximum Frame Rate or Reduced Frame Rate.

In some implementations, frame rate estimator 440 may behave as follows:

For each frame, the Frame-Rate Error Estimator 520 may check if the Static Frame Indication input from the static frame detector 490 and the generated encoder on/off signal are similar (Active or In-Active, represented as “1” or “0” respectively). Based on this condition, the Frame-rate Error may be “1” if they are similar and “0” if they are not similar, for example.

The Frame-Rate controller 530 may use the Frame-Rate Error Indication to test if there is a stable reduced frame rate. An example of an implementation of this function is a digital loop filter that uses the Frame-Rate Error indication as an input and outputs the frequency (Frame-Rate) control value into Frame-rate Generator. Such a Digital Loop Filter can be implemented as a Linear 1st or 2nd order loop filter, for example. Additionally or alternatively, non-linear behavior can be introduced into the loop.

Another logic function within the Frame-Rate controller 530 may check the number of “1” on the Frame Rate Error input during a predefined time window. If the number of “1”s is below a certain bound (LOCK_VALUE), then it means a stable Frame Rate has been identified. In this state, if the stable Frame Rate is below the Full-Frame Rate, the Reduced-Rate Mode may be entered.

If the Frame-Rate Estimator Control Logic 440 is operating in a Reduced-Rate Mode, and the Frame Rate Error input during a predefined time window goes above a pre-defined value (UNLOCK_VALUE), it may mean that the frame rate has changed and the Full-Rate Mode may be entered, where all video frames are encoded.

The encoder (not illustrated here) may have an additional encoder on/off input that controls if the next video frame will be encoded or not (see for example, the implementation described in FIG. 2). Such an additional encoder on/off input may be fed by the frame rate generator module. When the encoder is off, power consumption may be reduced and no packets/template P_skip packets (which are very small, take very little power and time to generate) may be transmitted. This reduces power consumption and wireless bandwidth.

Accordingly, video processing scheme 400 (see FIG. 4) and/or frame rate estimator 440 may enable saving power and wireless bandwidth when any repetitive static/non-static frame pattern is encoded for wireless display. One important use case is video playback utilizing a frame rate, which is lower than the refresh rate of the wireless display system (e.g. movie at 24 FPS, system set to refresh at 60 FPS). In such a case, an encoder incorporating video processing scheme 400 (see FIG. 4) and/or frame rate estimator 440 can be used to save significant amounts of power and wireless bandwidth.

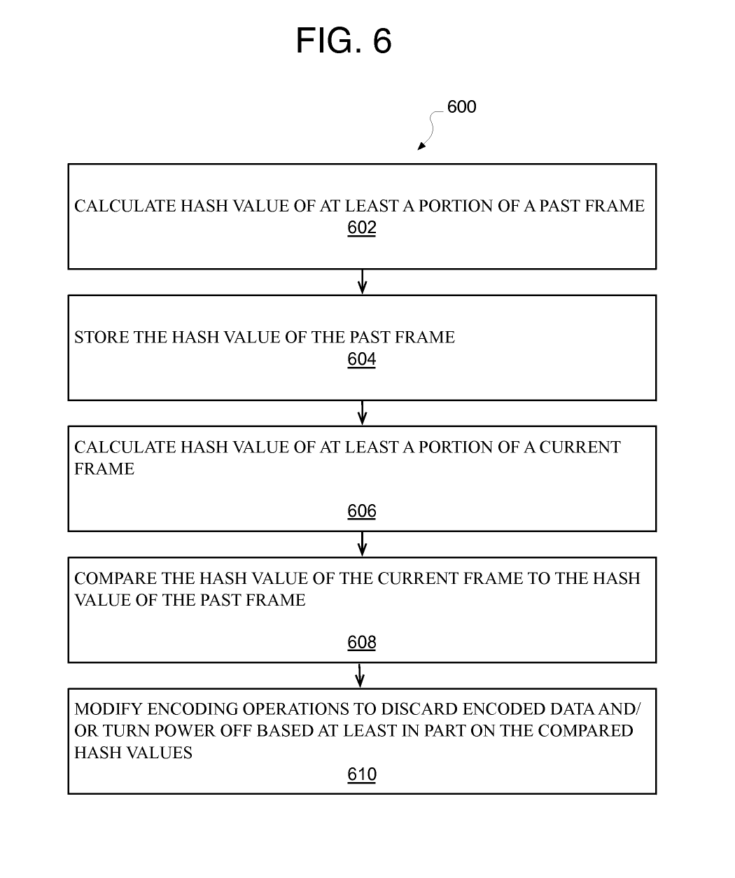

As will be discussed in greater detail below, video processing scheme 200 (e.g., FIG. 2A and/or FIG. 2B), video processing scheme 300 (e.g., FIG. 3), and/or video processing scheme 400 (e.g., FIG. 4) may be used to perform some or all of the various functions discussed below in connection with FIGS. 6 and/or 7.

FIG. 6 is a flow diagram illustrating an example process 600, arranged in accordance with at least some implementations of the present disclosure. Process 600 may include one or more operations, functions or actions as illustrated by one or more of operations 602, etc.

Process 600 may begin at operation 602, “CALCULATE HASH VALUE OF AT LEAST A PORTION OF A PAST FRAME”, where a hash value of at least a portion of a past frame may be calculated. For example, a hash value of at least a portion of a past frame may be calculated based at least in part on a received image to be encoded, via a hash calculation module.

Process 600 may continue at operation 604, “STORE THE HASH VALUE OF THE PAST FRAME”, where the hash value of at least a portion of the past frame may be stored. For example, the hash value of at least a portion of the past frame may be stored, via a hash value memory.

Process 600 may continue at operation 606, “CALCULATE HASH VALUE OF AT LEAST A PORTION OF A CURRENT FRAME”, where a hash value of at least a portion of a current frame may be calculated. For example, a hash value of at least a portion of a current frame may be calculated, via the hash calculation module.

Process 600 may continue at operation 608, “COMPARE THE HASH VALUE OF THE CURRENT FRAME TO THE HASH VALUE OF THE PAST FRAME”, where the hash value of at least a portion of the current frame may be compared to the at least a portion of the past frame. For example, the hash value of at least a portion of the current frame may be compared to the at least a portion of the past frame, via a comparison module.

For example, instead of storing the previous video frame in order to calculate the hash value, we want to avoid the memory needed for storing the previous video frame. Instead, there may be two hash memories: one that always contains the hash of the previous video frame and one that always contains the hash of the current video frame. When the last pixel of the new current video frame is received, the two hash values (past and current) may then be compared. In addition, the hash of the current video frame (which was just received) may be copied to the memory for the hash of the previous video frame when the next frame comes in, the process starts again where the hash of the current video frame iterates to being the hash of the past video frame as the next frame is processed

Process 600 may continue at operation 610, “MODIFY ENCODING OPERATIONS TO DISCARD ENCODED DATA AND/OR TURN POWER OFF BASED AT LEAST IN PART ON THE COMPARED HASH VALUES”, where encoding operations may be modified to discard encoded data and/or turn power off. For example, encoding operations may be modified to discard encoded data and/or turn power off based at least in part on the comparison of the hash value of at least a portion of the current frame to the at least a portion of the past frame, via an encoder.

Process 600 may provide for video coding, such as video encoding, decoding, and/or bitstream transmission techniques, which may be employed by a coder system as discussed herein.

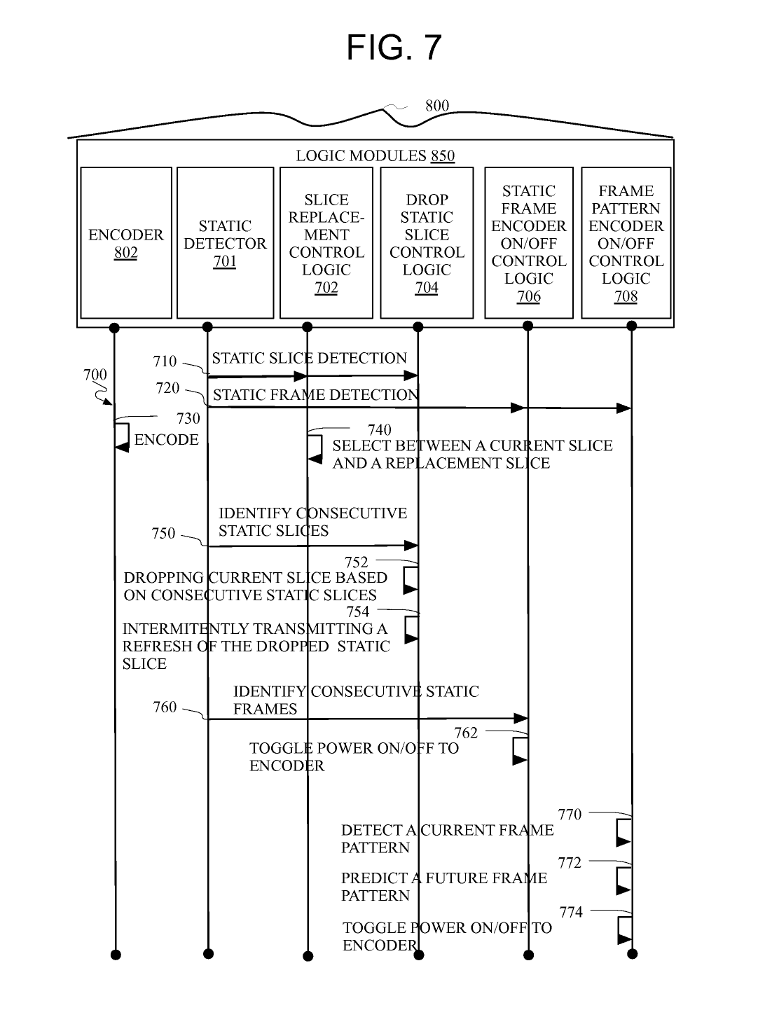

Some additional and/or alternative details related to process 600 and other processes discussed herein may be illustrated in one or more examples of implementations discussed herein and, in particular, with respect to FIG. 7 below.

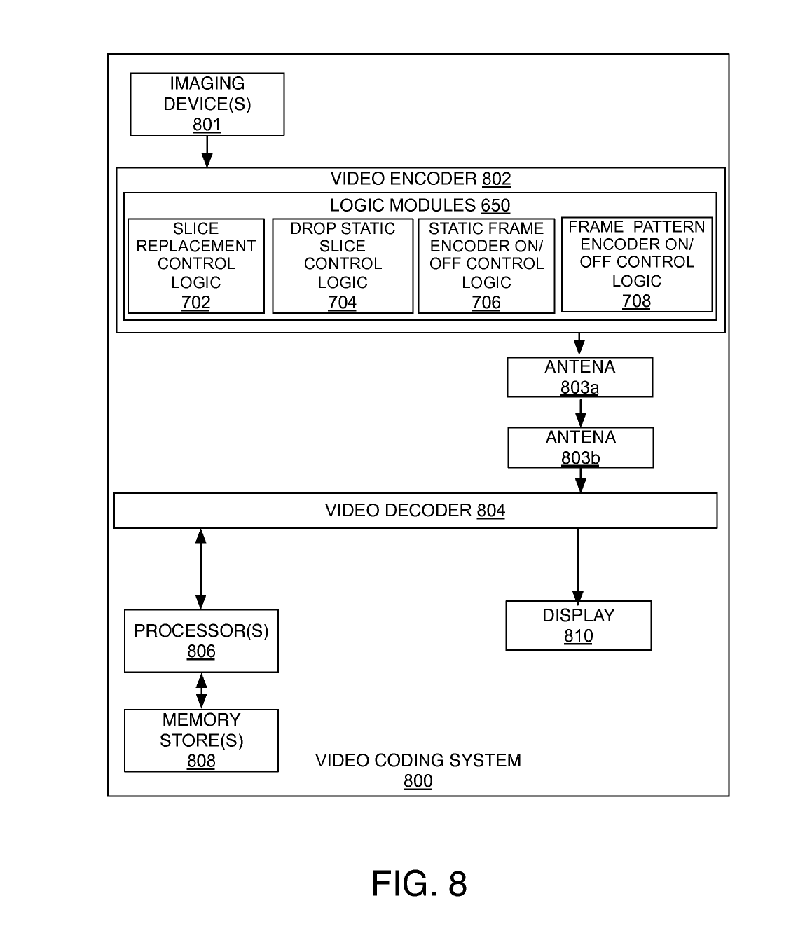

FIG. 7 provides an illustrative diagram of an example video coding system 800 (see, e.g., FIG. 8 for more details) and video coding process 700 in operation, arranged in accordance with at least some implementations of the present disclosure. In the illustrated implementation, process 700 may include one or more operations, functions or actions as illustrated by one or more of actions 710, etc.

By way of non-limiting example, process 700 will be described herein with reference to example video coding system 800 including coder 100 of FIG. 1, as is discussed further herein below with respect to FIG. 8. In various examples, process 700 may be undertaken by a system including both an encoder and decoder or by separate systems with one system employing an encoder (and optionally a decoder) and another system employing a decoder (and optionally an encoder). It is also noted, as discussed above, that an encoder may include a local decode loop employing a local decoder as a part of the encoder system.

As illustrated, video coding system 800 (see, e.g., FIG. 8 for more details) may include logic modules 850. For example, logic modules 850 may include any modules as discussed with respect to any of the systems or subsystems described herein. For example, logic modules 850 may include a static detector 701, a slice replacement logic module 702, a drop static slice drop logic module 704, a static frame encoder on/off logic module 706, a frame pattern encoder on/off logic module 708, and/or the like.

Process 700 may begin at operation 710, “STATIC SLICE DETECTION”, where static slices may be detected. For example, slices may be detected via static detector 701.

In some implementations, the hash value of a slice of the current frame may computed and compared to a previously computed and stored hash value of a slice of the past frame.

Similarly, Process 700 may continue at operation 720, “STATIC FRAME DETECTION”, where static frames may be detected. For example, static frames may be detected via static detector 701.

In some implementations, the hash value of a whole current frame may computed and compared to a previously computed and stored hash value of a whole past frame.

In some implementations, operations 710 and 720 may be preformed simultaneously or nearly simultaneously via the same or similar module.

Process 700 may continue at operation 730, “ENCODE”, where pixels of the current frame may be encoded into an encoded data stream in parallel to the calculation of the hash values. For example, pixels of the current frame may be encoded into an encoded data stream in parallel to the calculation of the hash values via encoder 802.

In some implementations, encoder 802 may be an Intra only-type supplemented with a P_skip support unit (not shown). For example, P_skip may be configured to provide an indication to a decoder to replace the P_skip slices with decoded pixels from an earlier decoded video frame. Although this is only one example, and other non-Intra only-type encoders might be used in conjunction with all or part of process 700.

Process 700 may continue at operation 740, “SELECT BETWEEN A CURRENT SLICE AND A REPLACEMENT SLICE”, where a selection may be made between a current slice and a replacement slice. For example, a selection may be made, via a selector module (illustrated here as slice replacement logic module 702), between the Intra encoded slice of the current frame, a replacement P_skip slice, and/or dropping the Intra encoded slice altogether, where the selection may be based at least in part on the comparison of the slice hash value of the current slice to the slice hash value of the past slice.

Process 700 may continue at operation 750, “IDENTIFY CONSECUTIVE STATIC SLICES”, where consecutive static slices may be identified. For example, a preset number of consecutive video frames may be identified, via static detector 701, where a given slice is static. Such identification may be based at least in part on the comparison of the slice hash value of the current slice to the slice hash value of the past slice.

Process 700 may continue at operation 752, “DROPPING CURRENT SLICE BASED ON CONSECUTIVE STATIC SLICES”, where a current slice may be dropped based at least in part on the identification of the preset number of consecutive video frame. For example, a current slice may be dropped, via the drop static slice control logic 704, based at least in part on the identification of the preset number of consecutive video frames where a given slice is static.

Process 700 may continue at operation 754, “INTERMITENTLY TRANSMITTING A REFRESH OF THE DROPPED STATIC SLICE”, where a refresh of the dropped static slice may be intermittently transmitted. For example, a refresh of the dropped static slice may be intermittently transmitted as an Intra refresh for the dropped static slice, via the drop static slice control logic 704.

Process 700 may continue at operation 760, “IDENTIFY CONSECUTIVE STATIC FRAMES”, where consecutive static frames may be identified. For example, consecutive static frames may be identified where a given frame is static, via static detector 701. In such an implementation, the identification may be based at least in part on the comparison of the current whole frame hash value to the past whole frame hash value.

Process 700 may continue at operation 762, “TOGGLE POWER ON/OFF TO ENCODER”, where power to the encoder may be toggled on/off. For example, power to the encoder 802 may be toggled off, via the static frame encoder on/of control logic 706, based at least in part on the identification of the preset number of consecutive video frames where a given frame is static. Likewise, power to the encoder 802 may be toggled on, via the static frame encoder on/of control logic 706, based at least in part on a periodic refresh and/or an identification that the current frame is not static.

Process 700 may continue at operation 770, “DETECT A CURRENT FRAME PATTERN”, where a current frame pattern may be predicted. For example, a current frame pattern may be predicted, via a frame rate estimator control logic 708, based at least in part on the comparison of the current whole frame hash value to the past whole frame hash value.

Process 700 may continue at operation 772, “PREDICT A FUTURE FRAME PATTERN”, where a future frame pattern may be predicted. For example, a future frame pattern may be predicted, via the frame rate estimator control logic 708, based at least in part on the detected current frame update pattern.

Process 700 may continue at operation 774, “TOGGLE POWER ON/OFF TO ENCODER”, where power to the encoder may be toggled on/off. For example, power to the encoder 802 may be toggled on/off, via the frame rate estimator control logic 708, based at least in part on the predicted frame update pattern.

For simplicity, additional details regarding the operation and details of frame rate estimator control logic 708 (which were described in more detail above with regard to FIG. 5) are not illustrated in FIG. 7. However, some of these aspects are described briefly below without numbering. For example, frame rate estimator control logic 708 may include a frame rate generator module, a frame rate error estimator module, and/or a frame rate controller module. Such a frame rate generator module of the frame rate estimator control logic may be configured to generate a programmable frame rate between 0 and the maximum frame rate at a pre-defined granularity. Such a frame rate error estimator module of the frame rate estimator control logic may be configured to estimate a frame rate error in phase and frequency between the incoming frame rate from the comparison module and the frame rate generated by frame rate generator module. Such a frame rate controller module of the frame rate estimator control logic may be configured to control the frame rate generator module based at least in part on the estimated frame rate error. Further, the frame rate controller module may be configured to determine whether to operate in a Maximum Frame Rate mode or a Reduced Frame Rate mode in response to a detection of a stable reduced frame rate.

Various components of the systems and/or processes described herein may be implemented in software, firmware, and/or hardware and/or any combination thereof. For example, various components of the systems and/or processes described herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures.

As used in any implementation described herein, the term “module” may refer to a “component” or to a “logic unit”, as these terms are described below. Accordingly, the term “module” may refer to any combination of software logic, firmware logic, and/or hardware logic configured to provide the functionality described herein. For example, one of ordinary skill in the art will appreciate that operations performed by hardware and/or firmware may alternatively be implemented via a software component, which may be embodied as a software package, code and/or instruction set, and also appreciate that a logic unit may also utilize a portion of software to implement its functionality.

As used in any implementation described herein, the term “component” refers to any combination of software logic and/or firmware logic configured to provide the functionality described herein. The software logic may be embodied as a software package, code and/or instruction set, and/or firmware that stores instructions executed by programmable circuitry. The components may, collectively or individually, be embodied for implementation as part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the systems discussed herein. Further, one of ordinary skill in the art will appreciate that operations performed by hardware and/or firmware may also utilize a portion of software to implement the functionality of the logic unit.

In addition, any one or more of the blocks of the processes described herein may be undertaken in response to instructions provided by one or more computer program products. Such program products may include signal bearing media providing instructions that, when executed by, for example, a processor may provide the functionality described herein. The computer program products may be provided in any form of computer readable medium. Thus, for example, a processor including one or more processor core(s) may undertake one or more operations in response to instructions conveyed to the processor by a computer readable medium.

FIG. 8 is an illustrative diagram of example video coding system 800, arranged in accordance with at least some implementations of the present disclosure. In the illustrated implementation, video coding system 800, although illustrated with both video encoder 802 and video decoder 804, video coding system 800 may include only video encoder 802 or only video decoder 804 in various examples. Video coding system 800 (which may include only video encoder 802 or only video decoder 804 in various examples) may include imaging device(s) 801, antennas 803a and 803b, one or more processor(s) 806, one or more memory store(s) 808, and/or a display device 810. As illustrated, imaging device(s) 801, antennas 803a and 803b, video encoder 802, video decoder 804, processor(s) 806, memory store(s) 808, and/or display device 810 may be capable of communication with one another.

In some implementations, video coding system 800 may include corresponding antenna 803a (on the encoder side) and 803b (on the decoder side). For example, antennas 803a and/or 803b may be configured to transmit or receive an encoded bitstream of video data, for example. Processor(s) 806 may be any type of processor and/or processing unit. For example, processor(s) 806 may include distinct central processing units, distinct graphic processing units, integrated system-on-a-chip (SoC) architectures, the like, and/or combinations thereof. In addition, memory store(s) 808 may be any type of memory. For example, memory store(s) 808 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 808 may be implemented by cache memory. Further, in some implementations, video coding system 800 may include display device 810. Display device 810 may be configured to present video data.

As shown, in some examples, video coding system 800 may include logic modules 850. While illustrated as being associated with video encoder 802, video decoder 804 may similarly be associated with identical and/or similar logic modules as the illustrated logic modules 850. Accordingly, video encoder 802 may include all or portions of logic modules 850. For example, imaging device(s) 801 and video encoder 802 may be capable of communication with one another and/or communication with logic modules that are identical and/or similar to logic modules 850. Similarly, video decoder 804 may include identical and/or similar logic modules to logic modules 850. For example, antenna 803, video decoder 804, processor(s) 806, memory store(s) 808, and/or display 810 may be capable of communication with one another and/or communication with portions of logic modules 850.

In some implementations, logic modules 850 may embody various modules as discussed with respect to any system or subsystem described herein. In various embodiments, some of logic modules 850 may be implemented in hardware, while software may implement other logic modules. For example, in some embodiments, some of logic modules 850 may be implemented by application-specific integrated circuit (ASIC) logic while other logic modules may be provided by software instructions executed by logic such as processors 806. However, the present disclosure is not limited in this regard and some of logic modules 850 may be implemented by any combination of hardware, firmware and/or software.

For example, logic modules 850 may include a slice replacement logic module 702, a drop static slice drop logic module 704, a static frame encoder on/off logic module 706, a frame pattern encoder on/off logic module 708, and/or the like configured to implement operations of one or more of the implementations described herein.

FIG. 9 is an illustrative diagram of an example system 900, arranged in accordance with at least some implementations of the present disclosure. In various implementations, system 900 may be a media system although system 900 is not limited to this context. For example, system 900 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 900 includes a platform 902 coupled to a display 920. Platform 902 may receive content from a content device such as content services device(s) 930 or content delivery device(s) 940 or other similar content sources. A navigation controller 950 including one or more navigation features may be used to interact with, for example, platform 902 and/or display 920. Each of these components is described in greater detail below.

In various implementations, platform 902 may include any combination of a chipset 905, processor 910, memory 912, antenna 913, storage 914, graphics subsystem 915, applications 916 and/or radio 918. Chipset 905 may provide intercommunication among processor 910, memory 912, storage 914, graphics subsystem 915, applications 916 and/or radio 918. For example, chipset 905 may include a storage adapter (not depicted) capable of providing intercommunication with storage 914.

Processor 910 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 910 may be dual-core processor(s), dual-core mobile processor(s), and so forth.

Memory 912 may be implemented as a volatile memory device such as, but not limited to, a Random Access Memory (RAM), Dynamic Random Access Memory (DRAM), or Static RAM (SRAM).

Storage 914 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 914 may include technology to increase the storage performance enhanced protection for valuable digital media when multiple hard drives are included, for example.

Graphics subsystem 915 may perform processing of images such as still or video for display. Graphics subsystem 915 may be a graphics processing unit (GPU) or a visual processing unit (VPU), for example. An analog or digital interface may be used to communicatively couple graphics subsystem 915 and display 920. For example, the interface may be any of a High-Definition Multimedia Interface, Display Port, wireless HDMI, and/or wireless HD compliant techniques. Graphics subsystem 915 may be integrated into processor 910 or chipset 905. In some implementations, graphics subsystem 915 may be a stand-alone device communicatively coupled to chipset 905.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further embodiments, the functions may be implemented in a consumer electronics device.

Radio 918 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 918 may operate in accordance with one or more applicable standards in any version.

In various implementations, display 920 may include any television type monitor or display. Display 920 may include, for example, a computer display screen, touch screen display, video monitor, television-like device, and/or a television. Display 920 may be digital and/or analog. In various implementations, display 920 may be a holographic display. Also, display 920 may be a transparent surface that may receive a visual projection. Such projections may convey various forms of information, images, and/or objects. For example, such projections may be a visual overlay for a mobile augmented reality (MAR) application. Under the control of one or more software applications 916, platform 902 may display user interface 922 on display 920.

In various implementations, content services device(s) 930 may be hosted by any national, international and/or independent service and thus accessible to platform 902 via the Internet, for example. Content services device(s) 930 may be coupled to platform 902 and/or to display 920. Platform 902 and/or content services device(s) 930 may be coupled to a network 960 to communicate (e.g., send and/or receive) media information to and from network 960. Content delivery device(s) 940 also may be coupled to platform 902 and/or to display 920.

In various implementations, content services device(s) 930 may include a cable television box, personal computer, network, telephone, Internet enabled devices or appliance capable of delivering digital information and/or content, and any other similar device capable of unidirectionally or bidirectionally communicating content between content providers and platform 902 and/display 920, via network 960 or directly. It will be appreciated that the content may be communicated unidirectionally and/or bidirectionally to and from any one of the components in system 900 and a content provider via network 960. Examples of content may include any media information including, for example, video, music, medical and gaming information, and so forth.

Content services device(s) 930 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 902 may receive control signals from navigation controller 950 having one or more navigation features. The navigation features of controller 950 may be used to interact with user interface 922, for example. In various embodiments, navigation controller 950 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 950 may be replicated on a display (e.g., display 920) by movements of a pointer, cursor, focus ring, or other visual indicators displayed on the display. For example, under the control of software applications 916, the navigation features located on navigation controller 950 may be mapped to virtual navigation features displayed on user interface 922. In various embodiments, controller 950 may not be a separate component but may be integrated into platform 902 and/or display 920. The present disclosure, however, is not limited to the elements or in the context shown or described herein.

In various implementations, drivers (not shown) may include technology to enable users to instantly turn on and off platform 902 like a television with the touch of a button after initial boot-up, when enabled, for example. Program logic may allow platform 902 to stream content to media adaptors or other content services device(s) 930 or content delivery device(s) 940 even when the platform is turned “off.” In addition, chipset 905 may include hardware and/or software support for (5.1) surround sound audio and/or high definition (7.1) surround sound audio, for example. Drivers may include a graphics driver for integrated graphics platforms. In various embodiments, the graphics driver may comprise a peripheral component interconnect (PCI) Express graphics card.

In various implementations, any one or more of the components shown in system 900 may be integrated. For example, platform 902 and content services device(s) 930 may be integrated, or platform 902 and content delivery device(s) 940 may be integrated, or platform 902, content services device(s) 930, and content delivery device(s) 940 may be integrated, for example. In various embodiments, platform 902 and display 920 may be an integrated unit. Display 920 and content service device(s) 930 may be integrated, or display 920 and content delivery device(s) 940 may be integrated, for example. These examples are not meant to limit the present disclosure.

In various embodiments, system 900 may be implemented as a wireless system, a wired system, or a combination of both. When implemented as a wireless system, system 900 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 900 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 902 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 9.

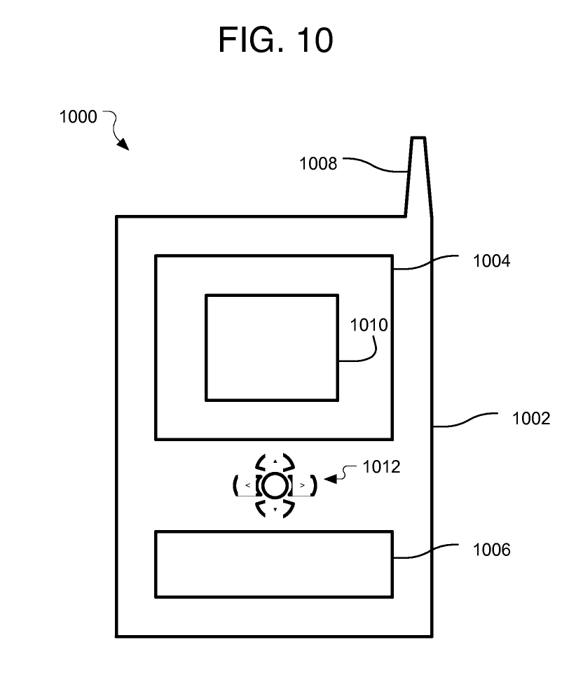

As described above, system 900 may be embodied in varying physical styles or form factors. FIG. 10 illustrates implementations of a small form factor device 1000 in which system 1000 may be embodied. In various embodiments, for example, device 1000 may be implemented as a mobile computing device a having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 10, device 1000 may include a housing 1002, a display 1004 which may include a user interface 1010, an input/output (I/O) device 1006, and an antenna 1008. Device 1000 also may include navigation features 1012. Display 1004 may include any suitable display unit for displaying information appropriate for a mobile computing device. I/O device 1006 may include any suitable I/O device for entering information into a mobile computing device. Examples for I/O device 1006 may include an alphanumeric keyboard, a numeric keypad, a touch pad, input keys, buttons, switches, rocker switches, microphones, speakers, voice recognition device and software, image sensors, and so forth. Information also may be entered into device 1000 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In addition, any one or more of the operations discussed herein may be undertaken in response to instructions provided by one or more computer program products. Such program products may include signal bearing media providing instructions that, when executed by, for example, a processor may provide the functionality described herein. The computer program products may be provided in any form of one or more machine-readable media. Thus, for example, a processor including one or more processor core(s) may undertake one or more of the operations of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the systems as discussed herein.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to further embodiments.

In one example, a computer-implemented method for wireless bandwidth reduction in an encoder may include calculating, via a hash calculation module, a hash value of at least a portion of a past frame based at least in part on a received image to be encoded. A hash value memory may store the hash value of at least a portion of the past frame. The hash calculation module may calculate a hash value of at least a portion of a current frame. A comparison module may compare the hash value of at least a portion of the current frame to the at least a portion of the past frame. An encoder may modify encoding operations to discard encoded data and/or turn power off based at least in part on the comparison of the hash value of at least a portion of the current frame to the at least a portion of the past frame.

In another example, in a computer-implemented method for wireless bandwidth reduction in an encoder, the comparison of the hash value of at least a portion of the current frame to the at least a portion of the past frame may include a comparison of slice hash values as well as a comparison of whole frame hash values. The modifying of the encoding operations may further including: encoding, via the encoder, pixels of the current frame into an encoded data stream in parallel to the calculation of the hash value of the slices of the current frame, where the encoder is an Intra only-type encoder supplemented with a P_skip support unit, where P_skip is configured to provide an indication to a decoder to replace the P_skip slices with decoded pixels from an earlier decoded video frame. A selector module may select between the Intra encoded slice of the current frame, a replacement P_skip slice, and/or dropping the Intra encoded slice altogether, where the selection is based at least in part on the comparison of the slice hash value of the current slice to the slice hash value of the past slice. The comparison module may identify a preset number of consecutive video frames where a given slice is static, where the identification is based at least in part on the comparison of the slice hash value of the current slice to the slice hash value of the past slice. A drop static slice control logic may drop the current slice from the encoded data stream based at least in part on the identification of the preset number of consecutive video frames where a given slice is static. The drop static slice control logic may intermittently transmit encode pixels as an Intra refresh for the dropped static slice. The comparison module may identify a preset number of consecutive video frames where a given frame is static, where the identification is based at least in part on the comparison of the current whole frame hash value to the past whole frame hash value. An encoder on/of control logic may toggle power off to the encoder based at least in part on the identification of the preset number of consecutive video frames where a given frame is static. The encoder on/of control logic may toggle power on to the encoder based at least in part on a periodic refresh and/or an identification that the current frame is not static. A frame rate estimator control logic may detect a current frame update pattern based at least in part on the comparison of the current whole frame hash value to the past whole frame hash value. The frame rate estimator control logic may predict a future frame update pattern based at least in part on the detected current frame update pattern. The frame rate estimator control logic may toggle power on/off to the encoder based at least in part on the predicted frame update pattern. The operation of frame rate estimator control logic may further include the following: generating, via a frame rate generator module of the frame rate estimator control logic, a programmable frame rate between 0 and the maximum frame rate at a pre-defined granularity; estimating, via a frame rate error estimator module of the frame rate estimator control logic, a frame rate error in phase and frequency between the incoming frame rate from the comparison module and the frame rate generated by frame rate generator module; controlling, via a frame rate controller module of the frame rate estimator control logic, the frame rate generator module based at least in part on the estimated frame rate error; and determining, via the frame rate controller module, whether to operate in a Maximum Frame Rate mode or a Reduced Frame Rate mode in response to a detection of a stable reduced frame rate.

In other examples, a system for wireless bandwidth reduction in an encoder may include a hash calculation module configured to calculate a hash value of at least a portion of a past frame based at least in part on a received image to be encoded. A hash value memory may be configured to store the hash value of at least a portion of the past frame. The hash calculation module may be configured to calculate a hash value of at least a portion of a current frame. A comparison module may be configured to compare the hash value of at least a portion of the current frame to the at least a portion of the past frame. An encoder may be configured to modify encoding operations to discard encoded data and/or turn power off based at least in part on the comparison of the hash value of at least a portion of the current frame to the at least a portion of the past frame.

In another example, in the system for wireless bandwidth reduction in an encoder the comparison of the hash value of at least a portion of the current frame to the at least a portion of the past frame includes a comparison of slice hash values as well as a comparison of whole frame hash values. The modifying of the encoding operations may further include: the encoder may be configured to encode pixels of the current frame into an encoded data stream in parallel to the calculation of the hash value of the slices of the current frame, where the encoder is an Intra only-type encoder supplemented with a P_skip support unit, where P_skip is configured to provide an indication to a decoder to replace the P_skip slices with decoded pixels from an earlier decoded video frame. A selector module may be configured to select between the Intra encoded slice of the current frame, a replacement P_skip slice, and/or dropping the Intra encoded slice altogether, where the selection is based at least in part on the comparison of the slice hash value of the current slice to the slice hash value of the past slice. The comparison module may be configured to identify a preset number of consecutive video frames where a given slice is static, where the identification is based at least in part on the comparison of the slice hash value of the current slice to the slice hash value of the past slice. A drop static slice control logic may be configured to drop the current slice from the encoded data stream based at least in part on the identification of the preset number of consecutive video frames where a given slice is static. The drop static slice control logic may be configured to intermittently transmit encoded pixels as an Intra refresh for the dropped static slice. The comparison module may be configured to identify a preset number of consecutive video frames where a given frame is static, where the identification is based at least in part on the comparison of the current whole frame hash value to the past whole frame hash value. An encoder on/of control logic may be configured to toggle power off to the encoder based at least in part on the identification of the preset number of consecutive video frames where a given frame is static. The encoder on/of control logic may be configured to toggle power on to the encoder based at least in part on a periodic refresh and/or an identification that the current frame is not static. A frame rate estimator control logic may be configured to detect a current frame update pattern based at least in part on the comparison of the current whole frame hash value to the past whole frame hash value. The frame rate estimator control logic may be configured to predict a future frame update pattern based at least in part on the detected current frame update pattern. The frame rate estimator control logic may be configured to toggle power on/off to the encoder based at least in part on the predicted frame update pattern. The operation of frame rate estimator control logic may further include the following: a frame rate generator module of the frame rate estimator control logic may be configured to generate a programmable frame rate between 0 and the maximum frame rate at a pre-defined granularity; a frame rate error estimator module of the frame rate estimator control logic may be configured to estimate a frame rate error in phase and frequency between the incoming frame rate from the comparison module and the frame rate generated by frame rate generator module; a frame rate controller module of the frame rate estimator control logic may be configured to control the frame rate generator module based at least in part on the estimated frame rate error; and the frame rate controller module may be configured to determine whether to operate in a Maximum Frame Rate mode or a Reduced Frame Rate mode in response to a detection of a stable reduced frame rate.

In a further example, at least one machine readable medium may include a plurality of instructions that in response to being executed on a computing device, causes the computing device to perform the method according to any one of the above examples.

In a still further example, an apparatus may include means for performing the methods according to any one of the above examples.

The above examples may include specific combination of features. However, such the above examples are not limited in this regard and, in various implementations, the above examples may include the undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed:

1. A computer-implemented method for wireless bandwidth reduction in an encoder, comprising:
calculating, via a hash calculation module, a hash value of at least a portion of a past frame based at least in part on a received image to be encoded;
storing, via a hash value memory, the hash value of at least a portion of the past frame;
calculating, via the hash calculation module, a hash value of at least a portion of a current frame;
comparing, via a comparison module, the hash value of at least a portion of the current frame to the at least a portion of the past frame; and
modifying, via an encoder, encoding operations to discard encoded data and/or turn power off based at least in part on the comparison of the hash value of at least a portion of the current frame to the at least a portion of the past frame.

2. The method of claim 1, wherein the comparison of the hash value of at least a portion of the current frame to the at least a portion of the past frame comprises a comparison of slice hash values.

3. The method of claim 1,
wherein the comparison of the hash value of at least a portion of the current frame to the at least a portion of the past frame comprises a comparison of slice hash values;
the modifying of the encoding operations further comprising:
encoding, via the encoder, pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame; and
selecting, via a selector module, between the Intra encoded slice of the current frame, a replacement P_skip slice, and/or dropping the Intra encoded slice altogether, wherein the selection is based at least in part on the comparison of the slice hash value of the current slice to the slice hash value of the past slice.

4. The method of claim 1,
wherein the comparison of the hash value of at least a portion of the current frame to the at least a portion of the past frame comprises a comparison of slice hash values;
the modifying of the encoding operations further comprising:
encoding, via the encoder, pixels of the current frame into an encoded data stream in parallel to the calculation of the hash value of the slices of the current frame; and
identifying, via the comparison module, a preset number of consecutive video frames where a given slice is static, wherein the identification is based at least in part on the comparison of the slice hash value of the current slice to the slice hash value of the past slice; and
dropping, via a drop static slice control logic, the current slice from the encoded data stream based at least in part on the identification of the preset number of consecutive video frames where a given slice is static; and
intermittently transmitting, via the drop static slice control logic, encode pixels as an Intra refresh for the dropped static slice.

5. The method of claim 1, wherein the comparison of the hash value of at least a portion of the current frame to the at least a portion of the past frame comprises a comparison of whole frame hash values.

6. The method of claim 1,
wherein the comparison of the hash value of at least a portion of the current frame to the at least a portion of the past frame comprises a comparison of whole frame hash values;
the modifying of the encoding operations further comprising:
encoding, via the encoder, pixels of the current frame into an encoded data stream in parallel to the calculation of the hash value of the current frame;
identifying, via the comparison module, a preset number of consecutive video frames where a given frame is static, wherein the identification is based at least in part on the comparison of the current whole frame hash value to the past whole frame hash value;
toggling power off, via an encoder on/of control logic, to the encoder based at least in part on the identification of the preset number of consecutive video frames where a given frame is static; and
toggling power on, via the encoder on/of control logic, to the encoder based at least in part on a periodic refresh and/or an identification that the current frame is not static.

7. The method of claim 1,
wherein the comparison of the hash value of at least a portion of the current frame to the at least a portion of the past frame comprises a comparison of whole frame hash values;
the modifying of the encoding operations further comprising:
encoding, via the encoder, pixels of the current frame into an encoded data stream in parallel to the calculation of the hash value of the current frame;
detecting, via a frame rate estimator control logic, a current frame update pattern based at least in part on the comparison of the current whole frame hash value to the past whole frame hash value;
predicting, via the frame rate estimator control logic, a future frame update pattern based at least in part on the detected current frame update pattern; and
toggling power on/off, via the frame rate estimator control logic, to the encoder based at least in part on the predicted frame update pattern.

8. The method of claim 1,
wherein the comparison of the hash value of at least a portion of the current frame to the at least a portion of the past frame comprises a comparison of whole frame hash values;
the modifying of the encoding operations further comprising:
encoding, via the encoder, pixels of the current frame into an encoded data stream in parallel to the calculation of the hash value of the current frame;
detecting, via a frame rate estimator control logic, a current frame update pattern based at least in part on the comparison of the current whole frame hash value to the past whole frame hash value;
predicting, via the frame rate estimator control logic, a future frame update pattern based at least in part on the detected current frame update pattern; and
toggling power on/off, via the frame rate estimator control logic, to the encoder based at least in part on the predicted frame update pattern;
wherein the operation of frame rate estimator control logic may further comprise the following:
generating, via a frame rate generator module of the frame rate estimator control logic, a programmable frame rate between 0 and the maximum frame rate at a pre-defined granularity;
estimating, via a frame rate error estimator module of the frame rate estimator control logic, a frame rate error in phase and frequency between the incoming frame rate from the comparison module and the frame rate generated by frame rate generator module;
controlling, via a frame rate controller module of the frame rate estimator control logic, the frame rate generator module based at least in part on the estimated frame rate error; and
determining, via the frame rate controller module, whether to operate in a Maximum Frame Rate mode or a Reduced Frame Rate mode in response to a detection of a stable reduced frame rate.

9. The method of claim 1,
wherein the comparison of the hash value of at least a portion of the current frame to the at least a portion of the past frame comprises a comparison of slice hash values;
the modifying of the encoding operations further comprising:
encoding, via the encoder, pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame;
selecting, via a selector module, between the Intra encoded slice of the current frame, a replacement P_skip slice, and/or dropping the Intra encoded slice altogether, wherein the selection is based at least in part on the comparison of the slice hash value of the current slice to the slice hash value of the past slice;
identifying, via the comparison module, a preset number of consecutive video frames where a given slice is static, wherein the identification is based at least in part on the comparison of the slice hash value of the current slice to the slice hash value of the past slice;
dropping, via a drop static slice control logic, the current slice from the encoded data stream based at least in part on the identification of the preset number of consecutive video frames where a given slice is static; and
intermittently transmitting, via the drop static slice control logic, encode pixels as an Intra refresh for the dropped static slice.

10. The method of claim 1,
wherein the comparison of the hash value of at least a portion of the current frame to the at least a portion of the past frame comprises a comparison of slice hash values as well as a comparison of whole frame hash values;
the modifying of the encoding operations further comprising:
encoding, via the encoder, pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame;
selecting, via a selector module, between the Intra encoded slice of the current frame, a replacement P_skip slice, and/or dropping the Intra encoded slice altogether, wherein the selection is based at least in part on the comparison of the slice hash value of the current slice to the slice hash value of the past slice;
identifying, via the comparison module, a preset number of consecutive video frames where a given slice is static, wherein the identification is based at least in part on the comparison of the slice hash value of the current slice to the slice hash value of the past slice;
dropping, via a drop static slice control logic, the current slice from the encoded data stream based at least in part on the identification of the preset number of consecutive video frames where a given slice is static;
intermittently transmitting, via the drop static slice control logic, encode pixels as an Intraday refresh for the dropped static slice;
identifying, via the comparison module, a preset number of consecutive video frames where a given frame is static, wherein the identification is based at least in part on the comparison of the current whole frame hash value to the past whole frame hash value;
toggling power off, via an encoder on/of control logic, to the encoder based at least in part on the identification of the preset number of consecutive video frames where a given frame is static;
toggling power on, via the encoder on/of control logic, to the encoder based at least in part on a periodic refresh and/or an identification that the current frame is not static;
detecting, via a frame rate estimator control logic, a current frame update pattern based at least in part on the comparison of the current whole frame hash value to the past whole frame hash value;
predicting, via the frame rate estimator control logic, a future frame update pattern based at least in part on the detected current frame update pattern; and
toggling power on/off, via the frame rate estimator control logic, to the encoder based at least in part on the predicted frame update pattern;
wherein the operation of frame rate estimator control logic may further comprise the following:
generating, via a frame rate generator module of the frame rate estimator control logic, a programmable frame rate between 0 and the maximum frame rate at a pre-defined granularity;
estimating, via a frame rate error estimator module of the frame rate estimator control logic, a frame rate error in phase and frequency between the incoming frame rate from the comparison module and the frame rate generated by frame rate generator module;
controlling, via a frame rate controller module of the frame rate estimator control logic, the frame rate generator module based at least in part on the estimated frame rate error; and
determining, via the frame rate controller module, whether to operate in a Maximum Frame Rate mode or a Reduced Frame Rate mode in response to a detection of a stable reduced frame rate.

11. A system for wireless bandwidth reduction in an encoder, comprising:
a hash calculation module configured to calculate a hash value of at least a portion of a past frame based at least in part on a received image to be encoded;
a hash value memory configured to store the hash value of at least a portion of the past frame;
the hash calculation module configured to calculate a hash value of at least a portion of a current frame;
a comparison module configured to compare the hash value of at least a portion of the current frame to the at least a portion of the past frame; and
an encoder configured to modify encoding operations to discard encoded data and/or turn power off based at least in part on the comparison of the hash value of at least a portion of the current frame to the at least a portion of the past frame.

12. The system of claim 11, wherein the comparison of the hash value of at least a portion of the current frame to the at least a portion of the past frame comprises a comparison of slice hash values.

13. The system of claim 11,
wherein the comparison of the hash value of at least a portion of the current frame to the at least a portion of the past frame comprises a comparison of slice hash values;
the modifying of the encoding operations further comprising:
the encoder configured to encode pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame; and
a selector module configured to select between the Intra encoded slice of the current frame, a replacement P_skip slice, and/or dropping the Intra encoded slice altogether, wherein the selection is based at least in part on the comparison of the slice hash value of the current slice to the slice hash value of the past slice.

14. The system of claim 11,
wherein the comparison of the hash value of at least a portion of the current frame to the at least a portion of the past frame comprises a comparison of slice hash values;
the modifying of the encoding operations further comprising:
the encoder configured to encode pixels of the current frame into an encoded data stream in parallel to the calculation of the hash value of the slices of the current frame; and
the comparison module configured to identify a preset number of consecutive video frames where a given slice is static, wherein the identification is based at least in part on the comparison of the slice hash value of the current slice to the slice hash value of the past slice; and
a drop static slice control logic configured to drop the current slice from the encoded data stream based at least in part on the identification of the preset number of consecutive video frames where a given slice is static; and
the drop static slice control logic configured to intermittently transmit encoded pixels as an Intra refresh for the dropped static slice.

15. The system of claim 11, wherein the comparison of the hash value of at least a portion of the current frame to the at least a portion of the past frame comprises a comparison of whole frame hash values.

16. The system of claim 11,
wherein the comparison of the hash value of at least a portion of the current frame to the at least a portion of the past frame comprises a comparison of whole frame hash values;
the modifying of the encoding operations further comprising:
the encoder configured to encode pixels of the current frame into an encoded data stream in parallel to the calculation of the hash value of the current frame;
the comparison module configured to identify a preset number of consecutive video frames where a given frame is static, wherein the identification is based at least in part on the comparison of the current whole frame hash value to the past whole frame hash value;
an encoder on/of control logic configured to toggle power off to the encoder based at least in part on the identification of the preset number of consecutive video frames where a given frame is static; and
the encoder on/of control logic configured to toggle power on to the encoder based at least in part on a periodic refresh and/or an identification that the current frame is not static.

17. The system of claim 11,
wherein the comparison of the hash value of at least a portion of the current frame to the at least a portion of the past frame comprises a comparison of whole frame hash values;
the modifying of the encoding operations further comprising:
the encoder configured to encode pixels of the current frame into an encoded data stream in parallel to the calculation of the hash value of the current frame;
a frame rate estimator control logic configured to detect a current frame update pattern based at least in part on the comparison of the current whole frame hash value to the past whole frame hash value;
the frame rate estimator control logic configured to predict a future frame update pattern based at least in part on the detected current frame update pattern; and
the frame rate estimator control logic configured to toggle power on/off to the encoder based at least in part on the predicted frame update pattern.

18. The system of claim 11, further comprising:
wherein the comparison of the hash value of at least a portion of the current frame to the at least a portion of the past frame comprises a comparison of whole frame hash values;
the modifying of the encoding operations further comprising:
the encoder configured to encode pixels of the current frame into an encoded data stream in parallel to the calculation of the hash value of the current frame;
a frame rate estimator control logic configured to detect a current frame update pattern based at least in part on the comparison of the current whole frame hash value to the past whole frame hash value;
the frame rate estimator control logic configured to predict a future frame update pattern based at least in part on the detected current frame update pattern; and
the frame rate estimator control logic configured to toggle power on/off to the encoder based at least in part on the predicted frame update pattern;
wherein the operation of frame rate estimator control logic may further comprise the following:
a frame rate generator module of the frame rate estimator control logic configured to generate a programmable frame rate between 0 and the maximum frame rate at a pre-defined granularity;
a frame rate error estimator module of the frame rate estimator control logic configured to estimate a frame rate error in phase and frequency between the incoming frame rate from the comparison module and the frame rate generated by frame rate generator module;
a frame rate controller module of the frame rate estimator control logic configured to control the frame rate generator module based at least in part on the estimated frame rate error; and
the frame rate controller module configured to determine whether to operate in a Maximum Frame Rate mode or a Reduced Frame Rate mode in response to a detection of a stable reduced frame rate.

19. The system of claim 11, further comprising:
wherein the comparison of the hash value of at least a portion of the current frame to the at least a portion of the past frame comprises a comparison of slice hash values;
the modifying of the encoding operations further comprising:
the encoder configured to encode pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame;
a selector module configured to select between the Intra encoded slice of the current frame, a replacement P_skip slice, and/or dropping the Intra encoded slice altogether, wherein the selection is based at least in part on the comparison of the slice hash value of the current slice to the slice hash value of the past slice;
the comparison module configured to identify a preset number of consecutive video frames where a given slice is static, wherein the identification is based at least in part on the comparison of the slice hash value of the current slice to the slice hash value of the past slice;
a drop static slice control logic configured to drop the current slice from the encoded data stream based at least in part on the identification of the preset number of consecutive video frames where a given slice is static; and
the drop static slice control logic configured to intermittently transmit encoded pixels as an Intra refresh for the dropped static slice.

20. The system of claim 11, further comprising:
wherein the comparison of the hash value of at least a portion of the current frame to the at least a portion of the past frame comprises a comparison of slice hash values as well as a comparison of whole frame hash values;
the modifying of the encoding operations further comprising:
the encoder configured to encode pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame;
a selector module configured to select between the Intra encoded slice of the current frame, a replacement P_skip slice, and/or dropping the Intra encoded slice altogether, wherein the selection is based at least in part on the comparison of the slice hash value of the current slice to the slice hash value of the past slice;
the comparison module configured to identify a preset number of consecutive video frames where a given slice is static, wherein the identification is based at least in part on the comparison of the slice hash value of the current slice to the slice hash value of the past slice;
a drop static slice control logic configured to drop the current slice from the encoded data stream based at least in part on the identification of the preset number of consecutive video frames where a given slice is static;
the drop static slice control logic configured to intermittently transmit encoded pixels as an Intraday refresh for the dropped static slice;
the comparison module configured to identify a preset number of consecutive video frames where a given frame is static, wherein the identification is based at least in part on the comparison of the current whole frame hash value to the past whole frame hash value;
an encoder on/of control logic configured to toggle power off to the encoder based at least in part on the identification of the preset number of consecutive video frames where a given frame is static;
the encoder on/of control logic configured to toggle power on to the encoder based at least in part on a periodic refresh and/or an identification that the current frame is not static;
a frame rate estimator control logic configured to detect a current frame update pattern based at least in part on the comparison of the current whole frame hash value to the past whole frame hash value;
the frame rate estimator control logic configured to predict a future frame update pattern based at least in part on the detected current frame update pattern; and
the frame rate estimator control logic configured to toggle power on/off to the encoder based at least in part on the predicted frame update pattern;
wherein the operation of frame rate estimator control logic may further comprise the following:
a frame rate generator module of the frame rate estimator control logic configured to generate a programmable frame rate between 0 and the maximum frame rate at a pre-defined granularity;
a frame rate error estimator module of the frame rate estimator control logic configured to estimate a frame rate error in phase and frequency between the incoming frame rate from the comparison module and the frame rate generated by frame rate generator module;
a frame rate controller module of the frame rate estimator control logic configured to control the frame rate generator module based at least in part on the estimated frame rate error; and
the frame rate controller module configured to determine whether to operate in a Maximum Frame Rate mode or a Reduced Frame Rate mode in response to a detection of a stable reduced frame rate.

21. At least one machine readable medium comprising: a plurality of instructions that in response to being executed on a computing device, causes the computing device to perform:
calculate a hash value of at least a portion of a past frame based at least in part on a received image to be encoded;
store the hash value of at least a portion of the past frame;
calculate a hash value of at least a portion of a current frame;
compare the hash value of at least a portion of the current frame to the at least a portion of the past frame; and
modify encoding operations to discard encoded data and/or turn power off based at least in part on the comparison of the hash value of at least a portion of the current frame to the at least a portion of the past frame.

22. The at least one machine readable medium method of claim 21, further comprising:
wherein the comparison of the hash value of at least a portion of the current frame to the at least a portion of the past frame comprises a comparison of slice hash values as well as a comparison of whole frame hash values;
the modifying of the encoding operations further comprising:
encode pixels of the current frame into an encoded data stream in parallel to the calculation of the hash value of the slices of the current frame, wherein the encoder is an Intra only-type encoder supplemented with a P_skip support unit, wherein P_skip is configured to provide an indication to a decoder to replace the P_skip slices with decoded pixels from an earlier decoded video frame;
select between the Intra encoded slice of the current frame, a replacement P_skip slice, and/or dropping the Intra encoded slice altogether, wherein the selection is based at least in part on the comparison of the slice hash value of the current slice to the slice hash value of the past slice;
identify a preset number of consecutive video frames where a given slice is static, wherein the identification is based at least in part on the comparison of the slice hash value of the current slice to the slice hash value of the past slice;
drop the current slice from the encoded data stream based at least in part on the identification of the preset number of consecutive video frames where a given slice is static;
intermittently transmit encoded pixels as an Intra refresh for the dropped static slice;
identify a preset number of consecutive video frames where a given frame is static, wherein the identification is based at least in part on the comparison of the current whole frame hash value to the past whole frame hash value;
toggle power off to the encoder based at least in part on the identification of the preset number of consecutive video frames where a given frame is static;
toggle power on to the encoder based at least in part on a periodic refresh and/or an identification that the current frame is not static;
detect a current frame update pattern based at least in part on the comparison of the current whole frame hash value to the past whole frame hash value;
predict a future frame update pattern based at least in part on the detected current frame update pattern; and
toggle power on/off to the encoder based at least in part on the predicted frame update pattern;
wherein the operation of frame rate estimator control logic may further comprise the following:
generate a programmable frame rate between 0 and the maximum frame rate at a pre-defined granularity;
estimate a frame rate error in phase and frequency between the incoming frame rate from the comparison module and the frame rate generated by frame rate generator module;
control the frame rate generator module based at least in part on the estimated frame rate error; and
determine whether to operate in a Maximum Frame Rate mode or a Reduced Frame Rate mode in response to a detection of a stable reduced frame rate.
